(19) United States
(12) Patent Application Publication
(10) Pub. No.: US 2013/0208129 A1
(43) Pub. Date: Aug. 15, 2013

(54) IMAGE ENHANCEMENT DEVICE FOR REDUCTION OF NOISE IN DIGITAL IMAGES

(71) Applicant: WESDYNE TRC AB, (US)

(72) Inventor: David Stenman, Sala (SE)

(73) Assignee: WESDYNE TRC AB, Taby (SE)

(21) Appl. No.: 13/748,894

(22) Filed: Jan. 24, 2013

(30) Foreign Application Priority Data
Jan. 24, 2012 (SE) 1250048-4

(51) Int. Cl. G06T 5/00

(52) U.S. Cl. CPC G06T 5/002
USPC 348/207.1

(57) ABSTRACT

The invention relates to an image enhancement device comprising an image recording device, configured to register a series of subsequent images of a particular object, whereby each image includes a matrix of pixels, each pixel representing a particular image content, a processing unit configured to execute de-noising operations to reduce noise in said series of subsequent images, and a screen. The noise is reduced by identifying at least one pixel of noise in an image, removing the image content of said pixel from the image and substituting said removed image content with replacement image content derived by overlapping the images of the series of subsequent images. Further, the processing unit is configured to overlap images by integrating replacement image content from a second image into a first image from which the image content has been removed.

### FIELD OF THE INVENTION

The present invention refers to an image enhancement device and a method for reducing noise in an image.

### BACKGROUND

Visual inspections are extensively used for control of components in many applications. In for example nuclear power plants different measurement and analyses techniques are used for these quality controls such as measuring energy output and radioactivity levels at different positions within the plant. Also, digital images and videos are constantly recorded, documented and analysed. The quality of the digital images must be sufficient so that they can be used for quality analyses. Similar challenges exist in many other applications.

The quality of images taken by cameras may be affected by noise. Such noise may be electric noise or optical noise. Examples of noise that may occur are luminescence noise or colour noise. Other noises may be caused by signals that have frequencies or amplitudes that deviate from the standard signals. Another example is statistical noise.

The quality of images decreases with increasing noise level. Therefore, many techniques have been developed to reduce noise in digital images. These de-noising operations can be executed after the image has been registered in an image recording device such as a camera. Some de-noising operations relate to the use of filters such as Gaussian noise filter, Sigma noise filer, Wiener filter, Speckle noise filter, and the like. Another de-noising operation or technique relates to applying an averaging method, whereby a series of images is executed from the same object. The noises in the subsequent images are then compared and averaged out such that an image is generated, wherein the noise is the average noise present in the series of subsequently registered images. Processing units such as PCs may be used for the execution of the de-noising operations. Most of the de-noising operations are suitable for reducing noises of low to moderate intensity. A disadvantage of these de-noising operations is that information from the images may be lost by executing these operations.

When the intensity of noise reaches above a certain threshold level, the known de-noising operations may no longer be satisfactory for the reduction of noise from an image. Besides, removing information from an image may not always be allowed. One example may be noise that originates from radiation in a nuclear power plant. This type of noise may affect an image to the extend that documentation and analyses are no longer possible, while it is prohibited to remove information from the image.

The noise may be visible in the images as one or more pixel in the image that has a different or more intense colour, or the pixel may be white or black. Such pixels may obliterate the quality of an image to such a degree that the image can no longer be used for quality controls.

Processes in plants need to be constantly monitored. Therefore, the quality of images taken during the quality controls must be maintained at a level that allows the images to be documented and analysed constantly. There is a need for a de-noising operation, which reduces noise from digital images. There is also a need for a de-noising operation, which does not remove information from an image. There is thus a need for a more intelligent de-noising operation or algorithm, whereby noise is removed from the image such that images can be documented and analysed but whereby the information in the image is not lost during the de-noising operation.

### SUMMARY OF THE INVENTION

An object of the present invention is to provide a device and a method that can be used for reducing noise from a digital image. Another object is to provide a device and method, whereby noise is removed from the image such that images can be documented and analysed but whereby the information in the image is not substantially lost during the de-noising operation. Preferably, the noise is reduced from the image after the image has been registered. Another object is to provide a device that provides images with reduced noise. A further object is to provide a device that can be used during operations in a nuclear power plant. Another object is to provide a device and method, which provides images, which have sufficient quality to allow documentation and analyses of the registered images, especially digital images taken from three dimensional objects. Yet another object is to provide a device and method, which allows three dimensional algorithms to be performed on the digital images obtained.

The object is achieved by an image enhancement device as defined in the claims, which is characterized in that the noise is reduced by identifying at least one pixel of noise in an image, removing the image content of said at least one pixel from the image and substituting said removed image content with replacement image content derived by overlapping the images of the series of subsequent images,

whereby noise is defined as a physical obstruction or transient distortion between the object and the image recording device, and

whereby the processing unit is configured to execute one or more other de-noising operations before or after one or more images are visualised on the screen, and whereby one de-noising operation is selected from an averaging method.

In one embodiment, the processing unit is configured to overlap the images by integrating replacement image content from a second image within the series of subsequent images into a first image from which the image content of at least one pixel has been removed and whereby the integrated replacement image content is free of noise.

In another embodiment, the processing unit is configured to identify at least one pixel of noise by comparing a value for colour and/or intensity of the image content of the at least one pixel with a reference value for colour and/or intensity.

An advantage of the device according to the present invention is that noise in the registered images is reduced to a level which allows the images to be used for documentation and analyses. No information needs to be deleted from the image. This de-noising operation can thus be used in for example a nuclear power plant. The processing unit is able to perform the de-noising operation without delay. Therefore, the images can be used during an operation or process. The device allows three dimensional algorithms to be performed on the digital images obtained.

No additional de-noising operation will be needed if the noise level in an image is low enough. Therefore, it may be convenient and less time consuming to visualise the image on a screen before performing a de-noising operation. When the level of noise increases, the operator may decide to start one or more de-noising operation for the reduction of noise prior to visualizing the image on a screen.

In one embodiment, the series of subsequent images are registered from a static object.

In another embodiment, the series of subsequent images are registered from a moving object, whereby the processing unit is configured to perform an additional step of identifying areas of overlap between two or more images in the series of images before reducing noise in said area of overlap and exclusively execute the de-noising operations with respect to said area of overlap.

In a further embodiment, the processing unit is configured to extract a background in an image and build a panorama image of the moving object.

An advantage of the present invention is that the de-noising operation can be performed on both static and moving objects. Three dimensional algorithms can be performed on the digital images obtained from both static and moving objects.

In one embodiment, the processing unit is configured to apply a threshold level for defining the value of noise. The type of noise may depend on the environment and the circumstances in which a digital image recording device such as a camera is being used.

In another embodiment, the processing unit is configured to adapt the threshold level to the origin of the noise and the environment in which the image recording device is used. Threshold levels are preferable determined depending on the origin of the noise and the environment in which the image device is used. Allowing threshold levels to be adapted to the needs and the environment in which it is to be used, increases the flexibility for the use of device according to the invention.

In one embodiment, the induced noise comprises one or more of radiation noise, thermal noise, multiplicative noise, impulsive noise, luminescence noise, colour noise and one or more of physical obstruction or transient distortion between the object and the image recording device.

In an alternative embodiment, the processing unit is configured to eliminate the noise entirely.

Another advantage of the device of the present invention is that by combining the image content of a series of images, the noise in an image may be eliminated completely or almost completely, without losing any or hardly any information in the image. Only the noise will be deleted from the images. Especially with respect to images taken from moving and/or three dimensional objects, the image enhancement device allows for the documentation and analyses of images that cannot be used today due to the high level of noise present in the images. Three dimensional algorithms may now be performed on such images. The device of the present invention can advantageously be used for the reduction of noise with a high intensity.

In another embodiment, the digital recording device comprises an analogue camera and a converting device configured to convert an analogue image to a digital image.

Yet another embodiment, the digital image recording device is a digital camera.

The object of the present invention is also achieved by a method for reducing noise as defined in the claims, which is characterized by—reducing the noise by identifying at least one pixel of noise in an image,
removing the image content of said at least one pixel from the image, and
substituting said removed image content with replacement image content derived by overlapping the images of the series of subsequent images, and
executing one or more other de-noising operations before or after one or more images are visualised on the screen (5), whereby one de-noising operation is selected from an averaging method using the processing unit (4),
   whereby noise is defined as a physical obstruction or transient distortion between the object and the image recording device (2).

In one embodiment of the method, the processing unit is configured to overlap the images by integrating replacement image content from a second image within the series of subsequent images into a first image from which the image content of at least one pixel has been removed and whereby the integrated replacement image content is free of noise.

In another embodiment of the method, the processing unit is configured to identify at least one pixel of noise by comparing a value for colour and/or intensity of the image content of the at least one pixel with a reference value for colour and/or intensity.

In a further embodiment of the method, the processing unit is configured to apply a threshold level for defining the value of noise.

### BRIEF DESCRIPTION OF THE DRAWINGS

FIG. 1 shows a schematical view of the image enhancement device.

FIG. 2 shows schematically how noise can be reduced from images.

FIG. 3 shows schematically how noise can be removed from images registered from a moving object.

### DETAILED DESCRIPTION

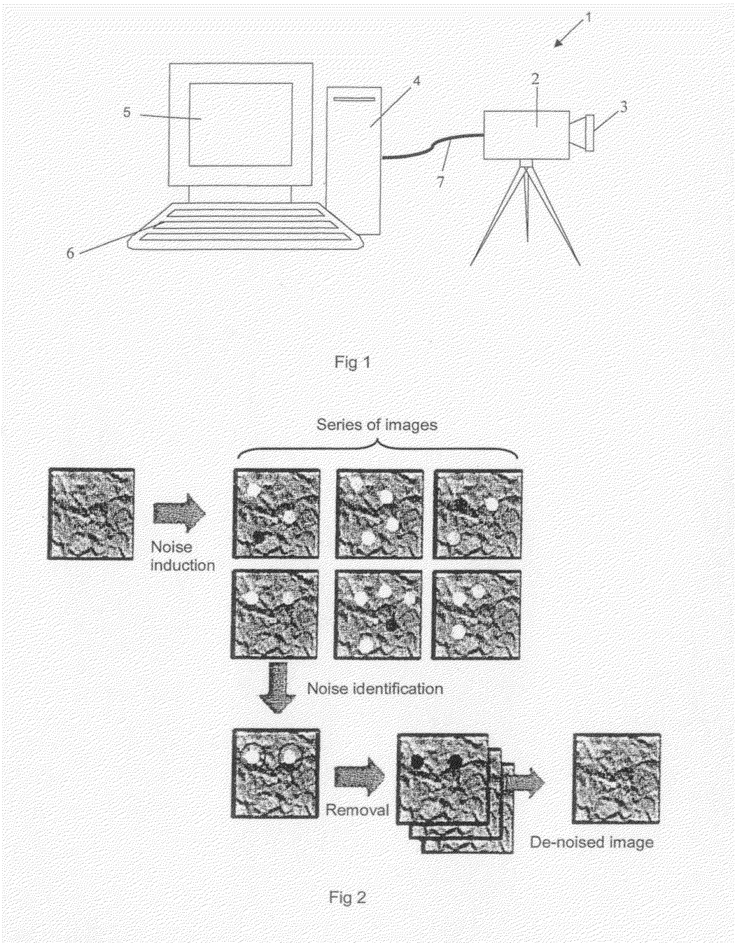

FIG. 1 shows an image enhancement device 1 of the present invention. The device 1 comprises at least one digital image recording device 2. The device 2 has a lens 3. This image recording device 2 may be a camera such as a photo camera or a video camera. The image recording device 2 is preferably adapted to produce a signal for live transmission or for recording. Preferably, the image recording device 2 has an image sensor with a relatively high resolution. The images from an object positioned in front of the lens 3 are registered with help of the image recording device 2. The image recording device 2 may be a digital device. The image recording device 2 may also comprise an analogue camera and a converting device, whereby the converting device is configured to convert the analogue image into a digital image. The analogue camera and the conversion device may be physically separated.

Also shown in FIG. 1 is a processing unit 4, for instance represented by a computer. The processing unit 4 is configured to execute de-noising operations and to generate (de-noised) images. The processing unit 4 may be physically separated from the image recording device 2. The processing unit 4 may be located in a mixing facility where one or more images can be stored and processed jointly. More than one image recording device 2 may be connected to one processing unit 4. This way images from different recording devices 2, located at different positions within a plant, can be processed in a processing unit 4 at a central location within the plant. The processing unit 4 may also be integrated in the image recording device 2. The processing unit 4 may be connected to a screen 5, where the images can be visualised. An input device 6 such as a keyboard may be present in or connected to the image enhancement device 1. Cables 7 may be used for connections between the individual parts 2, 3, 4, 5, 6 of the image enhancement device 1. In FIG. 1 a cable 7 is present between the image recording device 2 and the processing unit 4. One or more connections between the individual parts 2, 3, 4, 5, 6 may also be wireless.

A “pixel” or “picture element” is defined as a single point in a raster image, or the smallest addressable screen element in a display device. It is the smallest unit of an image that can be represented or controlled. Pixels are normally arranged in a two-dimensional grid where each pixel has its own address. The address of a pixel corresponds to its coordinates within the grid. Each pixel is a sample of an original image. More samples typically provide more accurate representations of the original image. In colour image systems, a colour is typically represented by three or four component intensities such as red, green, and blue, or cyan, magenta, yellow, and black. The intensity of each pixel is variable.

Noise, such as radiation, electrical or optical noise, may become apparent in an image in different ways. Noise may prevent the registering of the image in such a way that no longer each pixel is a sample of an original image. Instead, some pixels will have a deviating colour or intensity compared to adjacent pixels. Noise may also become visible in an image as one or more spot, each covering more than one adjacent pixel, that have deviating colour or intensities compared to surrounding pixels.

It is to be understood that the method of the present invention may be used to reduce both amplitude and frequency of noise and that the method is not dependent on the origin or intensity of the noise and may thus be used for the reduction of any type of noise at any level of noise. Examples of noises may be thermal noise, multiplicative noise, impulsive noise, luminescence noise and colour noise. The invention is suitable for reducing noise induced by radiation, such as nuclear radiation. Noise may also be defined as a disturbance or interference. Examples of such noise may be a physical obstruction or transient distortion between the object and the image recording device 2 such as air bubbles, water droplets (including snow flakes), steam, gas, reflections, which may be moving or heat movements. Mixtures of different type of noises may be present as well. In a series of images taken from the same object, the type of noise(s) may be different between one image and the subsequent image.

Each pixel has its own address in the two-dimensional grid. The colour and/or intensities of the image content of pixels in subsequent images that have the same address can be compared. Because the images are taken from the same object, the colour and intensities of the image content of pixels that have the same address is expected to be the same or substantially the same and can be assigned a reference value. The reference value is the value for colour or intensity, e.g. light intensity, as measured in each pixel in each image of the series of images. For example, in a particular pixel in an image taken from one object, the colour value of the image content may have a value of 55. The value for the colour in the same pixel in subsequent images is expected to have the same or substantially the same value of 55 (between 50 and 60).

The noise can be identified as image content of a pixel which has a value for colour and/or intensity that deviates from the reference value. For example a value for colour below 50 or above 60. The de-noising operation or algorithm of the present invention is adapted to identify pixels that have an image content with deviating values. The image content of such one or more pixel is subsequently removed from the image. The removed image content is than replaced by a replacement image content. The replacement image content is obtained from image content of pixels in another image within the series of images taken from the same object. This other image may be any image in the series of images. The image content of the replacement pixel from the other image must be positioned at the same address in the pixel grid. The values for the colour and intensity for the replacement image content of the replacement pixel must have the reference values.

The de-noising method above may be performed in different ways. The values of amplitudes and frequencies of an image content may be measured and compared with amplitude and frequency of a reference value. Any deviations from a reference value can than be identified. The identified noise may be classified as allowable noise or not. Threshold levels for values may be defined for this purpose. Image content that has a noise below and/or above a threshold level may be allocated a threshold value. For example, noise of a signal below the threshold level may be allocated value 1. Noise of a signal at or above the threshold level may be allocated a value 2. This noise may be defined as high intensity noise.

Alternatively, a value 1 may be allocated to noise that has a value that deviates by a predetermined (allowable) percentage from a threshold value, e.g. 0 to 25% (low intensity noise). Example of moderate or medium intensity noise may be noise that deviates by a predetermined (allowable) percentage from a threshold value, whereby the deviation is larger compared to the deviation for the low intensity noise, e.g. 25 to 50%.

A value 2 may allocated to noise that has a value that deviates by a predetermined (non-allowable) percentage from a threshold value, e.g. 50 to 100%, 75 to 100%, or over 100% (high intensity noise).

In the device 1 according to the present invention, the processing unit 4 may be configured to allocate different threshold values and to process the noise with the allocated threshold values. The one or more pixel that has an image content with a noise value that has been allocated the threshold value 2 will be processed by removing the image content of said pixel from the images.

FIG. 2 shows a series of images in which noise has been induced. After identification of the noises, and possibly allocation of threshold values to the different noises of the image content per pixel per image, the one or more pixels with values that deviate from the reference values (threshold value 2) are being removed. The removed image content of the pixel is than replaced with a replacement image content derived by overlapping the images of the series of subsequent images.

This overlapping may be implemented by integrating an image content of a pixel from another image, whereby the replacement image content does not have noise (e.g. a colour or intensity value deviating from the reference value). The other image may be the previous image or the next or second next image in the series of images or any other image.

Alternatively, after having removed the image content in pixels with noise, the image content in the (remaining) pixels in the image may be added to the image content of pixels of other images in the series of images. This summing of image contents of pixels, which have the same address in the grid, and originate from a particular number of images (e.g. 10, 20, 50) will result in an image, which is free of noise without losing any information from the original images.

The choice of the image from which the replacement image content is taken and the exact number of images per series as well as other details may depend on the environment and the circumstances in which the digital image recording device 2 is used such as type of noise(s) and amount and level of noise(s) that is to be eliminated. The method can easily be adapted to each specific environment and circumstances by adjusting the de-noising operation/algorithm.

Apart from identifying colour and intensity values variations versus a referenced background, other mechanisms for the detection of noise may be applied. It may for example be possible to identify the type of noise or radiation and the type of image recording acquisition electronics and than use this information to determine how these interact to form various types of coloured or black or white noise in the images. An algorithm may be self learning such as neural network type algorithms. Algorithms may detect shapes, forms, colours, intensities or distribution patterns. Also, noise may be identified as a movement of a spot at a certain speed and velocity such as noise (spots) popping in and out of the image with a limited lifetime or with certain distribution frequencies. Any combinations of mechanisms for identification of noise may be applied as well.

Three dimensional algorithms may be performed on the obtained images. Such images may be three dimensional picture images and three dimensional mapping for example obtained by combining a laser device with an image recording device 2.

The method can be combined with any other de-noising operation. For example, the processing unit may be configured to execute one or more de-noising operations selected from Sigma noise filtering, Gaussian noise filtering, applying a multiresolution or pyramid method, applying an averaging method, Wiener filtering, homomorphic filtering, Speckle noise and Medium filtering, applying a wavelet spatial frequency decomposition method, amplitude filtering and frequency filtering. Such other de-noising operation(s) may be executed before or after reducing the noise according to the method described above.

For example, an averaging method may be used to reduce noise, which method comprises averaging the noise present in a series of subsequent images registered from one object and generating an averaged image with reduced intensity noise of said object. The noise is typically low or moderate intensity noise, but may include high intensity noise.

The above mentioned method for reducing noise in digital images may be performed on static objects. However, the method may also be used for images registered from moving objects such as moving tubes, running assembly lines and running liquids such as water.

For the reduction of noise from moving objects, the processing unit 4 will be configured to perform an additional step of identifying areas of overlap between a series of images before reducing noise. The area of overlap may be defined as a matrix of adjacent pixels (spot) in an image that are identical or highly similar. The image content of pixels comprised in these spots does not remain at the same position/address in the subsequent images but moves within the grid. The processing unit 4 will first identify these spots before identifying noise and executing the de-noising operation(s) with respect to said area of overlap according to the method described above.

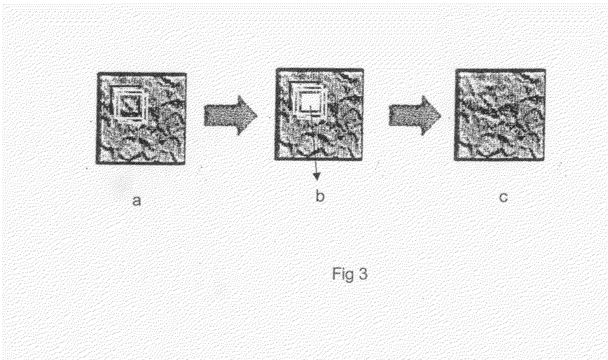

FIG. 3 shows an example of image enhancement in a moving object. Area of overlap b in the moving snapshot a can be used for the de-noising operation. In this way an image c can be obtained with enhanced noise reduction from a moving object.

All the operations performed by processing unit 4 may be controlled by means of a programmed computer apparatus. The present invention extends to a computer program, particularly computer programs on or in a carrier, adapted for putting the invention into practice. The program may be in the form of source code, object code, a code intermediate source and object code such as in partially compiled form, or in any other form suitable for use in the implementation if the method according to the invention. The program may either be a part of an operating system, or be a separate application. The carrier may be any entity or device capable of carrying the program. For example, the carrier may comprise a storage medium, such as a Flash memory, a ROM (Read Only Memory), for example a CD (Compact Disc) or a semiconductor ROM, an EPROM (Erasable Programmable ROM), an EEPROM (Electrically Erasable ROM), or a magnetic recording medium, for example a floppy disc. Further, the carrier may be a transmissible carrier such as an electrical or optical signal, which may be conveyed via electrical or optical cable or by radio or by other means. When the program is embodied in a signal, which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

The present invention is not limited to the embodiments disclosed but may be varied and modified within the scope of the following claims.

What is claimed is:

1. An image enhancement device, comprising:
a digital image recording device configured to register a series of subsequent images of a particular object, whereby each image comprises a matrix of pixels, each pixel representing a particular image content;
a processing unit configured to execute one or more de-noising operations to reduce induced noise in said series of subsequent images; and
a screen for visualising one or more registered images, wherein,
the noise is reduced by identifying at least one pixel of noise in an image, removing the image content of said at least one pixel from the image and substituting said removed image content with replacement image content derived by overlapping the images of the series of subsequent images,
whereby noise is defined as a physical obstruction or transient distortion between the object and the image recording device, and
whereby the processing unit is configured to execute one or more other de-noising operations before or after one or more images are visualised on the screen, and whereby one de-noising operation is selected from an averaging method.

2. The image enhancement device according to claim 1, wherein the processing unit is configured to overlap the images by integrating replacement image content from a second image within the series of subsequent images into a first image from which the image content of at least one pixel has been removed and whereby the integrated replacement image content is free of noise.

3. The image enhancement device according to claim 1, wherein the processing unit is configured to identify at least one pixel of noise by comparing a value for colour and/or intensity of the image content of the at least one pixel with a reference value for colour and/or intensity.

4. The image enhancement device according to claim 1, wherein the series of images are registered from a static object.

5. The image enhancement device according to claim 1, wherein the series of subsequent images are registered from a moving object, whereby the processing unit is configured to perform an additional step of identifying areas of overlap between two or more images in the series of images before reducing noise in said area of overlap and exclusively execute the de-noising operations with respect to said area of overlap.

6. The image enhancement device according to claim 5, wherein the processing unit is configured to extract a background in an image and build a panorama image of the moving object.

7. The image enhancement device according to claim 3, wherein the processing unit is configured to apply a threshold level for defining the value of noise.

8. The image enhancement device according to claim 7, wherein the processing unit is configured to adapt the threshold level to the origin of the noise and the environment in which the image recording device is used.

9. The image enhancement device according to claim 1, wherein the induced noise comprises one or more of radiation noise, thermal noise, multiplicative noise, impulsive noise, luminescence noise, colour noise and one or more of physical obstruction or transient distortion between the object and the image recording device.

10. The image enhancement device according to claim 1, wherein the processing unit is configured to eliminate the noise entirely.

11. The image enhancement device according claim 1, wherein the digital recording device comprises an analogue camera and a converting device configured to convert an analogue image to a digital image

12. The image enhancement device according claim 1, wherein the digital image recording device is a digital camera.

13. A method for reducing noise in a series if images registered using an image enhancement device comprising:
a digital image recording device configured to register a series of subsequent images of a particular object, whereby each image comprises a matrix of pixels, each pixel representing a particular image content;
a processing unit configured to execute one or more de-noising operations to reduce induced noise in said series of subsequent images;
a screen for visualising one or more registered images;
reducing the noise by identifying at least one pixel of noise in an image;
removing the image content of said at least one pixel from the image; and
substituting said removed image content with replacement image content derived by overlapping the images of the series of subsequent images; and
executing one or more other de-noising operations before or after one or more images are visualised on the screen, whereby one de-noising operation is selected from an averaging method using the processing unit;
whereby noise is defined as a physical obstruction or transient distortion between the object and the image recording device.

14. The method according to claim 13, wherein the processing unit is configured to overlap the images by integrating replacement image content from a second image within the series of subsequent images into a first image from which the image content of at least one pixel has been removed and whereby the integrated replacement image content is free of noise.

15. The method according to claim 13, wherein the processing unit is configured to identify at least one pixel of noise by comparing a value for colour and/or intensity of the image content of the at least one pixel with a reference value for colour and/or intensity.

16. The method according to claim 15, wherein the processing unit is configured to apply a threshold level for defining the value of noise.
